(19) United States
(12) Patent Application Publication
(10) Pub. No.: US 2009/0223380 A1
(43) Pub. Date: Sep. 10, 2009

(54) HORIZONTAL TOASTING DEVICE HAVING RELATIVELY SMALL TOP HEATING MEANS

(75) Inventor: Timotheus Johannes Maria Van Aken, Hoogenveen (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/300,798

(22) PCT Filed: May 9, 2007
(86) PCT No.: PCT/IB07/51741

§ 371 Date: Nov. 14, 2008

(30) Foreign Application Priority Data
May 18, 2006 (EP) 06114141.2

(51) Int. Cl. A47J 37/06

(52) U.S. Cl. 99/332; 99/389; 99/390; 99/401

(57) ABSTRACT

A toaster (1) of the horizontal type comprises a bottom housing element (11) accommodating bottom heating elements (20) and a top housing element (13) accommodating top heating elements. The top housing element (13) is arranged at a higher level than the bottom housing element (11), in a normal operative orientation of the toaster (1). Foodstuff to be toasted is arranged between the housing elements (11, 13). In order to have a great visibility to the foodstuff, the top housing element (13) has smaller horizontal dimensions than the bottom housing element (11) which has certain horizontal dimensions in view of the fact that the foodstuff is indirectly supported on the bottom housing element (11). Hence, a horizontally oriented heating surface which is defined by the top heating elements is also smaller than a horizontally oriented heating surface which is defined by the bottom heating elements (20).

The present invention relates to a device for toasting foodstuff such as slices of bread, which is intended for receiving, holding and toasting the foodstuff in a substantially horizontal direction, and which has means for generating heat during a toasting process and comprising top heating means and bottom heating means, wherein, in an operative orientation of the device, the top heating means are positioned at a higher level than the bottom heating means and above the bottom heating means as seen in a vertical direction, and wherein the top heating means mainly serve for heating a top portion of the foodstuff during a toasting process, while the bottom heating means mainly serve for heating a bottom portion of the foodstuff during a toasting process.

A toasting device as described in the opening paragraph is known, for example from DE 100 05 452 A 1. The known toasting device is a toaster which comprises a housing with a heating chamber and a vertically displaceable support for supporting foodstuff to be toasted. Due to the fact that the support is vertically displaceable, the height of the heating chamber is variable, and the toaster is suitable to be used for the purpose of toasting foodstuff of various sizes, including thin slices of bread and bread rolls.

For the purpose of providing heat during a toasting process, the known toaster further comprises two heating elements, namely a heating element that is arranged in a ceiling of the interior space of the housing and a heating element that is arranged in the support. In order to prevent heat loss during a toasting process, the interior space of the toaster is closed, wherein an access opening is arranged in a lower region of the toaster. When the toaster is loaded with foodstuff, the support is at a low level, and the foodstuff is placed on the support, through the access opening. Subsequently, the support is lifted to an upper region of the toaster, so that a lower room having the access opening is separated from the heating chamber, and the heating chamber is completely closed off. In the wall of the heating chamber, a viewing window is arranged, so that the toasting process may be observed by a user of the toaster.

A disadvantage of the toaster known from DE 100 05 452 A 1 is that a user is only allowed to have a limited view on foodstuff which is subjected to a toasting process, despite the presence of the viewing window. In particular, it is difficult to view a top side of the foodstuff, as the view is hindered by the ceiling of the interior housing, in which one of the heating elements of the toaster is arranged. As it appears to be very important to a user to be able to monitor the toasting process by checking the browning of the foodstuff, it is an objective of the present invention to provide another toasting device, wherein a larger portion of foodstuff which is present in the toasting device can be seen.

The objective of the present invention is achieved by a toasting device as mentioned in the opening paragraph, wherein the top heating means have smaller horizontal dimensions than the bottom heating means. In this context, horizontal dimensions of the heating means should be understood such as to mean dimensions of the heating means in a horizontal plane, assuming that the toasting device is in the operative orientation. According to the present invention, the top heating means define a smaller surface in a horizontal plane than the bottom heating means. In case the heating means comprise a heating coil, a U-shaped heating element or the like, the horizontal dimensions of the coil are determined on the basis of an imaginary horizontal plane covering all of the heating means.

It is noted that the fact that the top heating means have smaller horizontal dimensions than the bottom heating means does not mean that the top heating means are smaller than the bottom heating means in every horizontal direction. For example, in one horizontal direction, a dimension of the bottom heating means may correspond to a dimension of the top heating means. In case surfaces defined by the heating means in a horizontal plane are shaped like a rectangle, it is possible that long axes of symmetry of both rectangles have a similar length, while a short axis of symmetry of the rectangle associated with the top heating means is smaller than a short axis of symmetry of the rectangle associated with the bottom heating means. In any case, an area of the surface defined by the top heating means in a horizontal plane is smaller than an area of the surface defined by the bottom heating means.

In an embodiment of the toasting device according to the present invention, the horizontal dimensions of the bottom heating means may be approximately the same as the width and height dimensions of an average slice of bread, while the horizontal dimensions of the top heating means are considerably smaller. In this way, it is achieved that an extent to which a view from the above on the foodstuff to be toasted is hindered by the top heating means is as small as possible. Furthermore, the accessibility of the toasting device is enhanced, as a result of which it is easier to load the toasting device with foodstuff and to remove foodstuff from the toasting device, and to clean the toasting device.

It is noted that the heating means of the toasting device according to the present invention may be of any suitable type and shape. For example, the heating means may comprise one or more U-shaped or bar-shaped electrical heating elements, wherein the heating elements may be quartz heaters.

The toasting device may have an open structure, but is also possible for the toasting device to have a housing. In that case, it is advantageous if both the top heating means and the bottom heating means are accommodated in an element of the housing, so that a nice and attractive appearance of the toasting device is realized. Preferably, the housing element for accommodating the top heating means is as small as possible, so that a user of the toasting device experiences as little as possible hindrance from the housing element when looking at the foodstuff which is located inside the toasting device. As the horizontal dimensions of the top heating means are smaller than the horizontal dimensions of the bottom heating means, this implies that the housing element for accommodating the top heating means has smaller horizontal dimensions than the housing element for accommodating the bottom heating means.

The top heating means may comprise two or more heating elements. In such a case, the housing element for accommodating the top heating means may comprise two or more interspaced parts, wherein the horizontal dimensions of each of these parts are smaller than the horizontal dimensions of the housing element for accommodating the bottom heating means, and wherein the total of the horizontal dimensions of these parts is smaller than the horizontal dimensions of the housing element for accommodating the bottom heating means as well. In this way, it is realized that the toasting device according to the present invention provides good visibility to foodstuff which is placed in the device.

The housing of the toasting device may be fully closed. In that case, in order to allow a user to view foodstuff which is present inside the toasting device, it is practical for the housing to be at least partially translucent.

In many toasting processes, for example in a case of toasting a slice of bread, it is important that the foodstuff is equally heated, i.e. that a heating process which takes place at a bottom side of the foodstuff and a heating process which takes place at a top side of the foodstuff are substantially the same, so that both sides of the foodstuff will be browned to a similar extent. Therefore, it is important to ensure that heating powers at the top side and the bottom side are balanced. Depending on the actual configuration of the heating means, it may be advantageous if the top heating means have a larger heating capacity than the bottom heating means.

In a practical embodiment, the toasting device has a member for supporting the foodstuff in a substantially horizontal orientation during a toasting process, so that the foodstuff may be positioned at some distance from the bottom heating means. Preferably, the supporting member of the toasting device is positioned closer to the bottom heating means than the top heating means, as in such a case, a distance between the supporting member and the top heating means is relatively large, which contributes to a clear view on foodstuff which is placed on the supporting member. In the situation in which the distance between the item and the top heating means is larger than the distance between the item and the bottom heating means, similar browning on both sides of an item to be toasted may be achieved by applying top heating means having a larger heating capacity than the bottom heating means.

In a preferred embodiment of the toasting device according to the present invention, the member for supporting the foodstuff comprises a grid, so that the transfer of heat from the bottom heating means to foodstuff which is present on the supporting member is hindered as little as possible by the supporting member.

The versatility of the toasting device is enhanced when a mutual position of the supporting member and at least one of the top heating means and the bottom heating means is adjustable. Therefore, it is preferred when this is realized in any suitable manner. For example, when the supporting member is movably arranged between the bottom heating means and the top heating means, it is possible to vary a distance between the supporting member and the top heating means, so that the toasting device is capable of accommodating foodstuff of various sizes, including thin slices of bread and bread rolls. Additionally or alternatively, a mutual position of the top heating means and the bottom heating means may be adjustable. This is another way of varying a height of a space for receiving and accommodating foodstuff.

In order to prevent the bottom heating means from getting contaminated, for example by crumbs, it is practical to have a sheet of infrared light transmittable material above the bottom heating means. A suitable material is mica, for example. It is understood that the material of the sheet is preferably chosen such that the sheet does practically not hinder the transfer of heat from the bottom heating means to foodstuff. By having a sheet above the bottom heating means, the cleanability of the toasting device is enhanced. In this respect, it is noted that the sheet may be made of a dishwasher cleanable material.

The toasting device may be equipped with controlling means such as a microcontroller for controlling the operation of the heating means. Preferably, such controlling means are adapted to control the top heating means and the bottom heating means separately. This is advantageous in view of various situations, for example a situation in which a user of the toasting device only wants the top heating means to be activated in order to melt a topping of foodstuff which is present in the device.

As in many toasting processes, it is preferred to realize equal browning on both a top side of foodstuff and a bottom side of foodstuff, it is preferred if the controlling means are adapted to control the heating means accordingly. However, as the top heating means are smaller than the bottom heating means, and have a lower weight than the bottom heating means, this requires specific measures. According to a feasible possibility, the controlling means are adapted to start the bottom heating means first and to start the top heating means at a later stage when the device is operated to perform a toasting process. According to another feasible possibility, the controlling means are adapted to operate the bottom heating means at a relatively high power level during a predetermined period of time after a toasting process has been started, and to operate the bottom heating means at a lower power level when the predetermined period of time has ended, in other words, the controlling means are adapted to provide the bottom heating means with a power boost at the start of a toasting process. In both cases, the size difference between the top heating means and the bottom heating means may be compensated for, so that the desired equal browning of the foodstuff is obtained.

The present invention will now be explained in greater detail with reference to the Figures, in which equal or similar parts are indicated by the same reference signs, and in which:

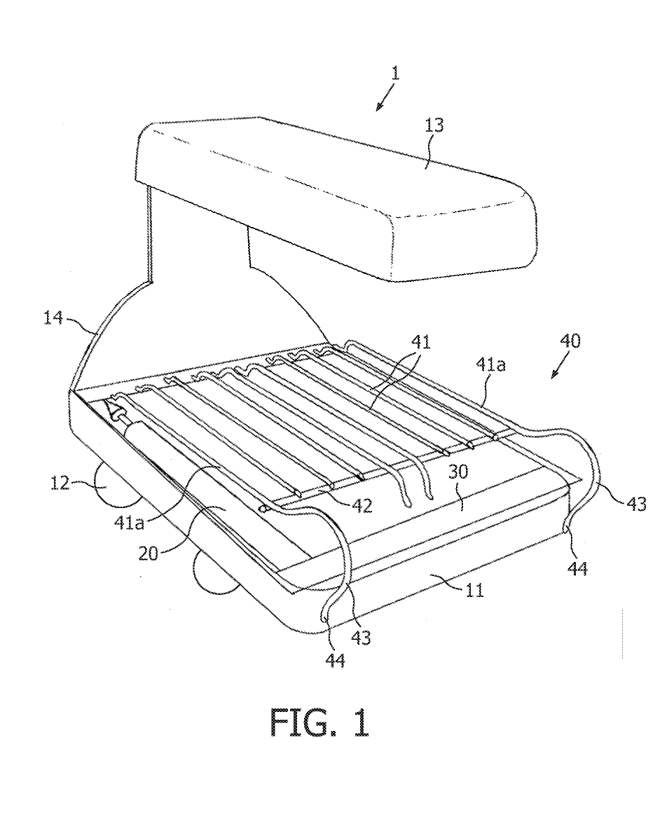

FIG. 1 diagrammatically shows a perspective view of a toasting device according to a first preferred embodiment of the present invention;

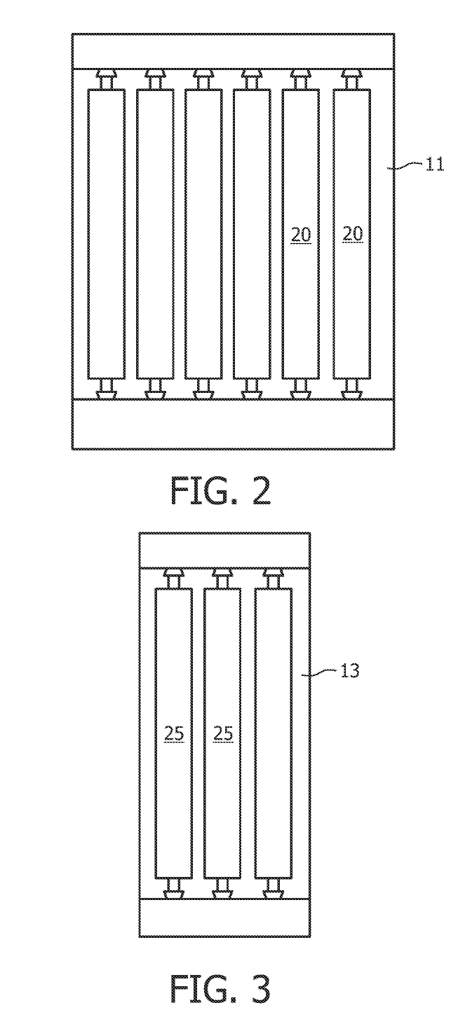

FIG. 2 diagrammatically shows a top view of a portion of the toasting device as shown in FIG. 1;

FIG. 3 diagrammatically shows a bottom view of another portion of the toasting device as shown in FIG. 1;

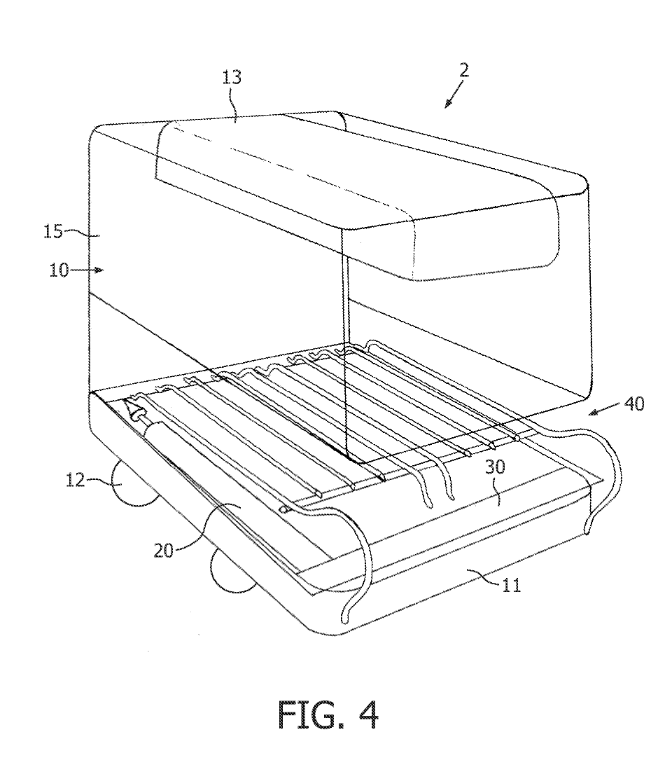

FIG. 4 diagrammatically shows a perspective view of a toasting device according to a second preferred embodiment of the present invention; and

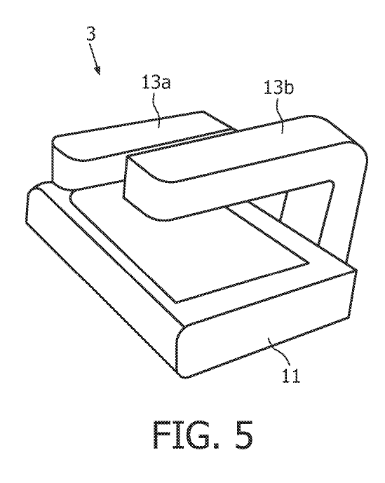

FIG. 5 diagrammatically shows a perspective view of a toasting device according to a third preferred embodiment of the present invention.

FIG. 1 shows a toasting device 1 according to a first preferred embodiment of the present invention. In the following, for sake of simplicity, the toasting device 1 will be referred to as toaster 1. The orientation in which the toaster 1 is shown in FIG. 1 is a normal operative orientation.

The toaster 1 comprises a bottom housing element 11, which is shaped like a shallow tray having an open side. In the operative orientation of the toaster 1, the open side is at the top of the bottom housing element 11. Inside the bottom housing element 11, bottom heating elements 20 are arranged, which serve for generating and emitting heat during operation of the toaster 1. For sake of clarity, in FIG. 1, only one bottom heating element 20 is shown. An example of the arrangement of a number of bottom heating elements 20 is shown in FIG. 2, which shows a top view of the bottom housing element 11 and the bottom heating elements 20 arranged therein.

At a bottom side of the bottom housing element 11, supports 12 are arranged. These supports 12 are preferably made of a heat-insulating material, so that transmittal of heat that is generated during operation of the toaster 1 to a surface on which the toaster 1 is resting is prevented.

The top side of the bottom housing element 11 is closed off by means of a cover sheet 30 of mica, glass or another material which is heat-resistant and infrared light transmittable. In the shown example, the material of the cover sheet 30 is also translucent. Preferably, the material of the cover sheet 30 is also dishwasher proof.

Furthermore, the toaster 1 comprises a grid 40, which serves for supporting foodstuff to be toasted or baked by means of the toaster 1 in a horizontal orientation. In FIG. 1, the grid 40 is shown in an operative position in the toaster 1, i.e. in a position in which the grid 40 is located on top of the cover sheet 30. The grid 40 is made of a heat-resistant material, for example metal, and may be of any suitable design. In the shown example, the grid 40 comprises a number of parallel supporting bars 41, which are interconnected by means of a connecting bar 42 extending perpendicular to the supporting bars 41. Furthermore, in the shown example, in order to facilitate placement of the grid 40 in the toaster 1 and removal of the grid 40 from the toaster 1, end portions 43 of two outer supporting bars 41 a are shaped like a hook. Moreover, at least one end portion of each supporting bar 41 is bent with respect to the rest of the supporting bar 41, so that most of the grid 40 is not in contact with the cover sheet 30 when the grid 40 is in place in the toaster 1.

The grid 40 may be connectable to the bottom housing element 11 and/or the cover sheet 30, but may also be freely placeable and removable. According to another possibility, the grid 40 may be pivotably connected to one of the bottom housing element 11 and the cover sheet 30. In the shown example, the grid 40 is in a proper position in the toaster 1 when ends 44 of both hook-shaped end portions 43 of the outer supporting bars 41 a are in contact with the outside of the bottom housing element 11.

Besides the bottom housing element 11, the toaster 1 comprises a top housing element 13, which is connected to the bottom housing element 11 through a connecting element 14. Like the bottom housing element 11, the top housing element 13 is shaped like a shallow tray having an open side. In the operative orientation of the toaster 1, the open side is at the bottom of the top housing element 13. The tray-shaped bottom housing element 11 and the tray-shaped top housing element 13 are extending substantially parallel with respect to each other, wherein a distance between the housing elements 11, 13 is determined by a length of the connecting element 14. Preferably, the connecting element 14 is connected to the outside of both housing elements 11, 13, as shown in FIG. 1, so that the connecting element 14 is not present in a space between the housing elements 11, 13.

Inside the top housing element 13, top heating elements 25 are arranged, which, like the bottom heating elements 20 arranged in the bottom housing element 11, serve for generating and emitting heat during operation of the toaster 1. The top heating elements 25 are not visible in FIG. 1, but these elements 25 are shown in FIG. 3, which shows a bottom view of the top housing element 13 and the top heating elements 25 arranged therein.

In the shown example, both the bottom heating elements 20 and the top heating elements 25 comprise quartz heaters, which are shaped like a bar. As the present invention does not relate to the heating elements 20, 25 as such, and various types of heating elements, including quartz heaters, are well-known in practice, the heating elements 20, 25 and their operation will not be further elucidated here.

According to an important aspect of the present invention, the top housing element 13 overlaps only a portion of the bottom housing element 11, as seen in a vertical direction. In particular, in the shown example, the top housing element 13 accommodates fewer heating elements 25 and has a smaller width than the bottom housing element 11. The collection of top heating elements 25 has a larger heating capacity than the collection of bottom heating elements 20. For example, the heating capacity of the top heating elements 25 is twice as large as the heating capacity of the bottom heating elements 20.

The operation of the toaster 1 is controlled by means of a microcontroller (not shown), which is part of the toaster 1. For the purpose of allowing a user to communicate with the microcontroller, the toaster 1 may comprise suitable means such as a push button, a turning knob or the like. For example, the user may be enabled to set a desired degree of browning. Furthermore, the toaster 1 comprises means (not shown) for indicating the end of a toasting process. Such means may comprise a buzzer, a light, or any other suitable means for providing a signal to a user.

In the following, a way of operating the toaster 1 for the purpose of toasting a slice of bread having melt cheese on top will be described.

First of all, the user places the slice of bread on the grid 40, while taking care that the side having the melt cheese is up. In the shown example, the horizontal dimensions of the grid 40 are related to the horizontal dimensions of an average slice of bread in such a way that the grid 40 is almost entirely covered by the slice of bread, with the exception of the hook-shaped end portions 43 of the outer supporting bars 41a. When the slice of bread is in the proper position, the slice of bread is at a relatively small distance from the cover sheet 30 and the bottom heating elements 20 which are present underneath the cover sheet 30, and at a relatively large distance from the top heating elements 25.

It is assumed that the user communicates to the microcontroller a desired degree of browning of the slice of bread, and also indicates the presence of a meltable topping. After the user has indicated that the toasting process may be started, which may simply be done by setting the desired degree of browning, for example, the microcontroller operates the bottom heating elements 20 to generate heat, so that a bottom side of the slice of bread is heated. After a predetermined period of time, the microcontroller operates the top heating elements 25 to generate heat as well, so that a top side of the slice of bread is heated as well. The heating process is performed during a period of time which is associated with the desired degree of browning as communicated by the user to the microcontroller. After that period of time, the microcontroller switches off the bottom heating means 20. Before the top heating means 25 are switched off as well, these means 25 are operated during a certain period of time for the purpose of melting the cheese. Depending on the duration of the process of toasting the bread, it is also possible that it is not necessary to switch off the top heating means 25 at a later stage than the bottom heating means 20. When the process of toasting the bread and melting the cheese has ended, the means for providing an indication to the user are activated.

The toasting process is performed while the slice of bread is much closer to the bottom heating means 20 than the top heating means 25. Moreover, the horizontal dimensions of a heating surface which is constituted by the bottom heating means 20 more or less correspond to the horizontal dimensions of the slice of bread, whereas the horizontal dimensions of a heating surface which is constituted by the top heating elements 25 are considerably smaller. Those are the reasons why the heating capacity of the top heating means 25 is larger than the heating capacity of the bottom heating means 20. In view of the fact that it is desirable to realize an equal browning at both the bottom side and the top side of the slice of bread, it is important that the top heating elements 25 can be operated at a higher power level than the bottom heating elements 20.

A reason for switching on the top heating elements 25 at a later stage than the bottom heating elements 20 during the toasting process resides in the fact that the bottom heating elements 20 have a higher mass and a lower heating capacity than the top heating elements 25. In this way, a situation in which the browning process at the top side of the slice of bread starts much earlier than the browning process at the bottom side of the slice of bread is avoided.

It will be understood that alternative solutions to the problem of realizing an equal browning at both sides of the slice of bread exist, in other words, that other possibilities of compensating for the fact that the top heating means 25 are at a larger distance from the slice of bread, and have higher heating capacity and lower mass exist. For example, it is possible to have a boost function for providing a power boost to the bottom heating elements 20 during a start-up of a toasting process. Another option is starting at a warm condition.

Due to the fact that the top housing element 13 having the top heating elements 25 is relatively small and is at a relatively large distance from the slice of bread, the user is granted a clear and unhindered view on a substantial portion of the slice of bread. In particular, during the toasting process, the user can watch the entire top side of the slice of bread in order to check the browning process and the melting process of the cheese. In case a slice of bread without a topping is toasted by means of the toaster 1, the user can check the browning of the bread. As it is known that a user likes to see for himself or herself how a browning and/or melting process is progressing, the fact that the toaster 1 allows for a clear view on foodstuff to be toasted is an advantageous feature of the toaster 1. Another advantage of the fact that the top housing element 13 having the top heating elements 25 is relatively small and is at a relatively high level is that there is a high accessibility, on the basis of which cleaning of the toaster 1 is relatively simple.

In the toaster 1 as shown in FIG. 1, a distance between the grid 40 for supporting foodstuff and the top housing element 13 having the top heating elements 25 is large enough for the toaster 1 to be able to receive and toast rolls, hot dogs, etc. In principle, it is possible that this distance is adjustable, for example in case at least one of the top housing element 13 and the grid 40 is movably arranged, or in case the grid 40 can be positioned in the toaster 1 at various height levels.

The toaster 1 as shown in FIG. 1 has an open structure. Due to this, the toasting process of foodstuff is highly visible and users of the toaster 1 are allowed to interact directly on the process. However, within the scope of the present invention, it is also possible to provide a toasting device 2 having a partially or completely closed housing 10. An example of a toasting device 2 having a partially closed housing 10 is shown in FIG. 4. Preferably, the housing 10 is at least partially translucent, so that a user of this type of toasting device 2 is still capable of monitoring the toasting process of foodstuff placed in the toasting device 2. The toasting device 2 as shown in FIG. 4 comprises a translucent top cap 15. This cap 15 may be removably arranged, so that it is easy for a user of the toasting device 2 to put foodstuff in place in the toasting device 2 and to remove foodstuff from the toasting device 2.

The toasting device according to the present invention may comprise more than one top housing element 13 having top heating elements 25. In FIG. 5, a toasting device 3 having two such top housing elements 13a, 13b is shown as an example. It is noted that, for sake of clarity, the grid 40 of the toasting device 3 is not shown in FIG. 5. Preferably, in case the level of the top housing elements 13a, 13b is adjustable, the level of the top housing elements 13a, 13b is individually adjustable, so that foodstuff of different sizes may be simultaneously toasted in the toasting device 3. By way of illustration, in FIG. 5, the two top housing elements 13a, 13b are shown at different levels.

It will be clear to a person skilled in the art that the scope of the present invention is not limited to the examples discussed in the foregoing, but that several amendments and modifications thereof are possible without deviating from the scope of the present invention as defined in the attached claims.

It is noted that the cover sheet 30 is not an essential component of the toasting device 1, 2, 3 according to the present invention. However, the application of the cover sheet 30 is preferred, in order to prevent the bottom heating elements 20 from getting contaminated, and to enhance the cleanability of the toasting device 1, 2, 3. Furthermore, especially in case a cover sheet 30 is present in the toasting device 1, 2, 3, the application of a grid 40 is not essential. However, in order to obtain good results from the toasting process, it is preferred if at least portions of a surface of the foodstuff to be toasted are left free.

The open side of the top housing element 13 may be closed off by means of a sheet or the like, but this is not necessary within the scope of the present invention. Such a sheet may be of the same type as the cover sheet 30 which may be applied for the purpose of closing off the open side of the bottom housing element 11.

In the foregoing, a toaster 1, 2, 3 of the horizontal type is described, which comprises a bottom housing element 11 accommodating bottom heating elements 20 and a top housing element 13 accommodating top heating elements 25. The top housing element 13 is arranged at a higher level than the bottom housing element 11, in a normal operative orientation of the toaster 1, 2, 3. Foodstuff to be toasted is arranged between the housing elements 11, 13.

In order to have a great visibility to the foodstuff, the top housing element 13 has smaller horizontal dimensions than the bottom housing element 11 which has certain horizontal dimensions in view of the fact that the foodstuff is indirectly supported on the bottom housing element 11. Hence, a horizontally oriented heating surface which is defined by the top heating elements 25 is also smaller than a horizontally oriented heating surface which is defined by the bottom heating elements 20. Preferably, in order to compensate for the size difference and to allow for equal browning of a top side and a bottom side of foodstuff to be toasted, the top heating elements 25 have a larger heating capacity than the bottom heating elements 20.

1. Device (1, 2, 3) for toasting foodstuff such as slices of bread, which is intended for receiving, holding and toasting the foodstuff in a substantially horizontal direction, and which has means (20, 25) for generating heat during a toasting process and comprising top heating means (25) and bottom heating means (20), wherein, in an operative orientation of the device (1, 2, 3), the top heating means (25) are positioned at a higher level than the bottom heating means (20) and above the bottom heating means (20) as seen in a vertical direction, wherein the top heating means (25) mainly serve for heating a top portion of the foodstuff during a toasting process, while the bottom heating means (20) mainly serve for heating a bottom portion of the foodstuff during a toasting process, and wherein the top heating means (25) have smaller horizontal dimensions than the bottom heating means (20).

2. Toasting device (1, 2, 3) according to claim 1, which has a housing (10) comprising elements (11, 13) for accommodating the heating means (20, 25), wherein a housing element (13) for accommodating the top heating means (25) has smaller horizontal dimensions than a housing element (11) for accommodating the bottom heating means (20).

3. Toasting device (3) according to claim 2, wherein the top heating means (25) comprise at least two heating elements (25), wherein the housing element (13) for accommodating the top heating means (25) comprises at least two interspaced parts (13a, 13b).

4. Toasting device (2) according to claim 2, wherein the housing (10) is at least partially translucent.

5. Toasting device (1, 2, 3) according to claim 1, wherein the top heating means (25) have a larger heating capacity than the bottom heating means (20).

6. Toasting device (1, 2, 3) according to claim 1, which has a member (40) for supporting the foodstuff in a substantially horizontal orientation during a toasting process, wherein the supporting member (40) is positioned closer to the bottom heating means (20) than the top heating means (25).

7. Toasting device (1, 2, 3) according to claim 6, wherein a mutual position of the supporting member (40) and at least one of the top heating means (25) and the bottom heating means (20) is adjustable.

8. Toasting device (1, 2, 3) according to claim 1, wherein a mutual position of the top heating means (25) and the bottom heating means (20) is adjustable.

9. Toasting device (1, 2, 3) according to claim 1, which has a sheet (30) of infrared light transmittable material, which sheet (30) is arranged above the bottom heating means (20).

10. Toasting device (1, 2, 3) according to claim 1, which has controlling means for controlling the operation of the top heating means (25) and the bottom heating means (20), wherein the controlling means are adapted to control these heating means (20, 25) separately.

11. Toasting device (1, 2, 3) according to claim 10, wherein the controlling means are adapted to start the bottom heating means (20) first and to start the top heating means (25) at a later stage when the device (1, 2, 3) is operated to perform a toasting process.

12. Toasting device (1, 2, 3) according to claim 10, wherein the controlling means are adapted to operate the bottom heating means (20) at a relatively high power level during a predetermined period of time after a toasting process has been started, and to operate the bottom heating means (20) at a lower power level when the predetermined period of time has ended.
